(19) United States
(12) Patent Application Publication
(10) Pub. No.: US 2009/0185080 A1
(43) Pub. Date: Jul. 23, 2009

(54) Controlling an electronic device by changing an angular orientation of a remote wireless-controller

(75) Inventor: Ruey-Der Lou, Hsinchu City (TW)

Correspondence Address: BO-IN LIN, 13445 MANDOLI DRIVE, LOS ALTOS HILLS, CA, 94022, US

(73) Assignee: IMU Solutions, Inc.

(21) Appl. No.: 12/321,527

(22) Filed: Jan. 21, 2009

Related U.S. Application Data
(60) Provisional application No. 61/011,666, filed on Jan. 18, 2008.

(51) Int. Cl. H04N 5/44

(52) U.S. Cl. 348/734; 348/E05.096

(57) ABSTRACT

A wireless remote controller for controlling multiple devices, including devices for home entertainment center such as TV, set-top box, audio and video recorders and players. The wireless remote control system is implemented to integrate and signals received from these devices for displaying selectable control items on an image display screen. The remote controller interfaces with the wireless remote control system to select different operation functions for each of these devices by physically moving and rotating the remote controller with requiring pressing down buttons on the remote controller in change selection items displayed on the image display screen.

This Non-provisional Application claims a Priority Date of Jan. 18, 2008 benefited from a Provisional Patent Applications 61/011,666 filed by an Applicant as one of the Inventors of this Application. The disclosures made in Patent Application 61/011,666 are hereby incorporated by reference in this Application.

### BACKGROUND OF THE INVENTION

1. Field of the Invention

This invention relates generally to a device and method for remotely control an electronic device with a wireless controller. More particularly, this invention relates to new devices and methods for implementing a wireless remote controller that enables a user to control multiple electronic devices with simplified and intuitive actions without requiring the actions of pressing down multiple control buttons.

2. Description of the Prior Art

Conventional techniques for providing wireless remote controller to control electronic device generally require a user to press down control buttons to control the electronic device. The operations are less intuitive and require more effort from the user and may slow down the operations when faster control operations are required such as playing a video game using the remote controller. Conventional methods and technologies are not able to resolve such difficulties and limitations.

The video broadcasting programs selected by turning the radio knob is the earlier operational method for selecting the entertainment programs in the earlier days. As increasingly more entertainment devices such as TV, DVD, video recorders, set-top boxes (STB) are available, more remote controllers each with different sets of push buttons are also used to control each of these devices. In order to simplify the operations of these remote controllers, selection menus are also displayed and provided to allow a user to make a selection by pushing buttons on the remote controllers. However, as newer display or entertainment devices have increasingly more functions, additional selections with corresponding additional push buttons are also added.

Furthermore, with the merge of network communication, home entertainment and computer functions, the traditional entertainment devices are also employed to surf the Internet, playing computer or Internet games, or carrying out computer functions. Such applications are expected to increase even more with the emergence of digital display technologies and the availability of high definition TV particularly with display signals transmitted in digital forms. In the meanwhile, it is not desirable to use a keyboard to operate the home entertainment devices. For these reasons, it is often necessary to employ more remote controllers that have even more push buttons to operate the home entertainment devices for selecting item on menus displayed on an image display screen to carry out more functions.

A user of a remote controller selects a selectable item on the selection menus by pushing buttons to highlight a selected item. The push buttons typically has arrow keys for moving to the right, left, up and down on the selection menu to make a selection. The home entertainment devices such as a HDTV or set-top box have a processor to receive and process these selection signals to control the entertainment devices and to display corresponding menus for step by step selection processes to control and operate the entertainment devices. A user has to look away from the display screen and look at the remote controller for making a selection in order to prevent the operation of pushing a wrong key. For the purpose of controlling a home entertainment device to carry out a specific function, a user often has to push many different buttons including different “arrow keys” for moving the selection and highlighting items to the “right, left, up or down” on the menu to finally achieve a targeted operation. Current technologies of applying the rotational movements of a remote controller for moving the highlight selections on the menus are stilled limited and inconvenient to operate. These devices are still limited by replacing the arrow keys by roll and yaw motions and keeping many push buttons for controlling the operations of the devices. A user is still required to look away from the display in order to gaze upon the controller in selecting and operate these push button keys thus limiting the usefulness of such remote controllers.

Therefore, a need still exists in the art of device control and operation to provide new and improved methods and processes to overcome the above-discussed difficulties and limitations.

### SUMMARY OF THE PRESENT INVENTION

One aspect of this invention is to provide wireless remote controller that enables a user to remotely control an electronic device provided with display controller to display user selectable operational item and a remote controller that is controllable to select the selectable operational items displayed on an image screen with simple and intuitive movement and may operate without requiring pressing down a control button.

Another aspect of this invention is to move the wireless remote controller with three-dimensional rotational movements. The remote controller transmits the rotational angular movements relative to each axis to an electronic device. The amount of angular movements are received and processed by the electronic device to control the operations of the electronic device. A user is provided with options to combine different movement of the controller with operations such as roll and haw to select different selectable operational items displayed on a control manual.

The remote controller is rotated relative to three non-parallel axes. For convenience of explanations, the remote controller has a rectangular shape and is rotated relative to three orthogonal axes perpendicular to each other. One of these three orthogonal axes is parallel to the elongate direction of the rectangular controller. The controller may be rotated with an angle of relative to the axis around the elongate axis of the rectangular controller, i.e., the pitch angle. The angular movement is received by the electronic device for generating a control signal to control the operation of the electronic device. The user may rotate the remote controller relative to two other axes, i.e., the roll and yaw angles. The electronic device receives and processes the angular movements relative to two other axes to generate different kinds of control signals. The control signals may be applied to move the highlighted items on a selection menu.

For a rectangular shaped controller, the elongated axis of the controller is assigned as the Y-axis. A user may apply the remote controller by first making a rotational movement around the Y-axis. Then, the user may control the highlighted item selections by rotating the controller around the X-axis and Z-axis. The sensitivity of the rotational movements along different axes may vary depending on specific hardware and software implementations. Such variations of sensitivity and control method adjustments with different rotational speed relative to different axes will also be discussed below. Special computational methods and calibration adjustment techniques are described to manage and deal with these variations and differences according to practical considerations of implementations.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram of a home entertainment center.

FIG. 2 is a diagram to illustrate the connections and transmissions of the audio and video signals between the audio and video devices for applying a remote controller of this invention.

FIG. 3 is functional block diagram of a remote controller of this invention.

FIG. 4 is a diagram for showing the rotational axes of a remote controller of this invention wherein when θ=0, the X, Y, and Z axes of the remote controller are the same as the reference axes represented by X′, Y′, and Z, axes.

FIG. 5 illustrates the operation of a remote controller of this invention with the selected highlighted items moved to the right or left according to the horizontal rotational movements of the remote controller.

FIG. 6 illustrates the operation of a remote controller of this invention with the selected highlighted items moved to the top or bottom according to the vertical rotational movements of the remote controller.

FIG. 7 illustrates the operation of a remote controller of this invention having an orientation of θ≠0 the Y-axis of the controller is the same as the reference axis Y′ but the X and Z axes are not parallel to the reference axes X′ and Z′.

FIG. 8 shows the selectable items displayed on an image screen divided into different regions with each region corresponding to a selectable option and each of the regions is corresponding to a range of angular orientation relative to the reference axes of the remote controller of this invention.

### DETAILED DESCRIPTION OF THE PREFERRED EMBODIMENT

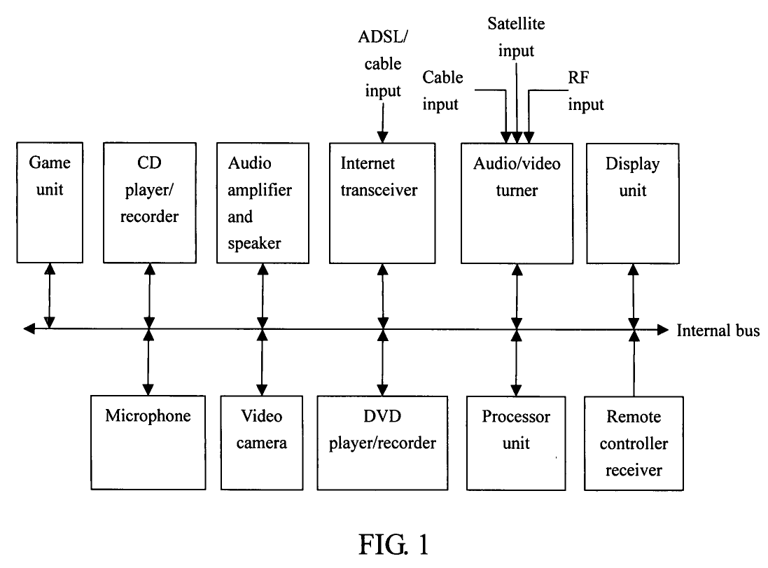

FIG. 1 is a functional block diagram of a home entertainment center of this invention. The home entertainment center includes a TV, a STB or other electronic devices controlled by remote controllers. FIG. 1 shows that the home entertainment center includes remote control signal receiver, a processor unit, a display unit, various recording and display apparatuses, game apparatuses, Hi-Fi stereo systems, RF receivers, cable receiver, ADSL receiver, satellite receivers, etc. The remote controller signal receiver receives the remote control signals and the processor unit applies the remote control signals to display selectable operational control options for different devices and systems according to the command and instructions embodied in the remote controller signals. Since there are many devices, apparatuses and systems as shown in FIG. 1, the menu shown on the display unit also includes multiple choices for these systems and devices depending on the remote controller signals.

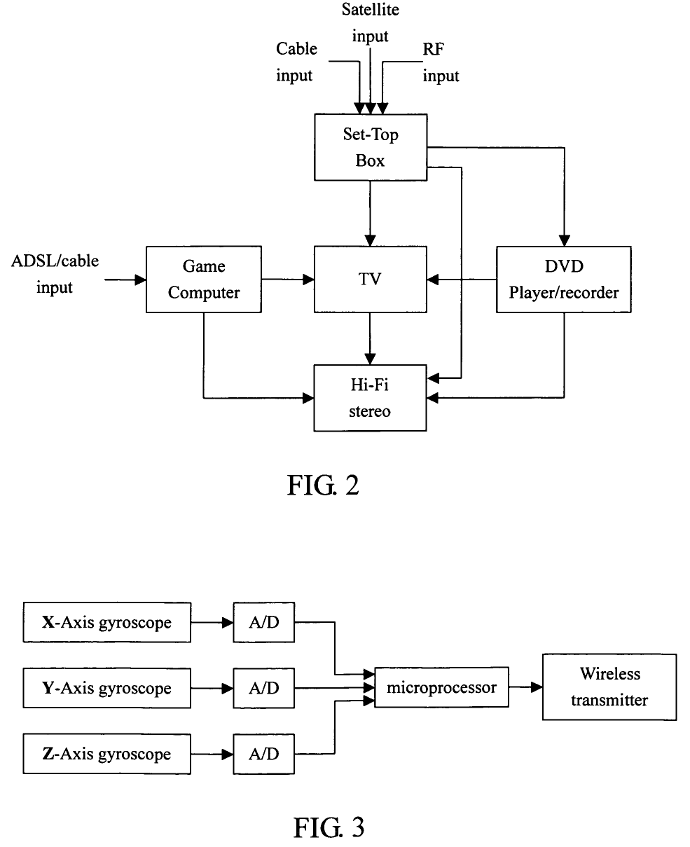

Because of these multiple devices and systems connected together in a home entertainment center as shown, there are integrated remote controller that has combined and integrated controller functions to send out commands and instruction to operate many different types of home entertainment devices and systems as shown in FIG. 2. The home entertainment center may include TV, recording and display systems, game machines, Hi-Fi stereo systems, RF receivers, cable receivers, ADSL receivers, satellite receivers, etc. The remote controller receiver receives commands and instructions from such integrated and combined remote controller to display menus on the display screen to allow a user to select and control different operational options of the home entertainment center.

The remote controller controls the movements of the selectable highlighted optional items with these selected items displayed on an image screen by moving and tilting the remote controller in different angular positions. Instead of pushing buttons to move the highlighted selected items on a selection menu as that required by the convention control systems, the user does not have to look away from the image screen in selecting and pushing a position shift button. The user holding the remote controller of this invention can simply move and rotate the remote controller to move the selected options to right, left, top or bottom with either a linear or a rotational movement to change the selected items display on an image screen. A user can quickly and conveniently change the control options intuitively and quickly with simple linear and/or rotational movement instead of pushing buttons. The embodiment is illustrated with a home entertainment center. Such remote controller operation can be applied to different kinds of electronic controller other than the apparatuses and devices incorporated in a home entertainment center.

Different kinds of detection methods can be applied to detect and determine the rotational movements of a remote controller. One exemplary embodiment is to install light emitting diodes (LED) on the remote controller and video camera may be installed on a home entertainment center to capture the images of the LED. A rotational movement of the remote controller that rotates the LED can be detected by the video camera and the amount and the directions of rotation is digital processed and analyzed by receiving and process the data captured by the video camera installed on the home entertainment center. In an alternate embodiment, the remote controller may include a radio frequency (RF) transmitter and the home entertainment center may include a radio frequency receiver for receiving RF signals from the remote controller to detect rotational movements of the remote controller. In another exemplary embodiment, the remote controller may include an earth-magnetic sensor and accelerometer, or alternate an earth-magnetic detector with a gyroscope or accelerometer with a gyroscope. Since the compact gyroscopes can be manufactured by applying the technologies of micro-electro-mechanical (MEM). Gyroscopes are readily available at reasonable price. In an exemplary embodiment, a remote controller is implemented either with three gyroscopes each functioning as a single-axis gyroscope or one gyroscope of three axes.

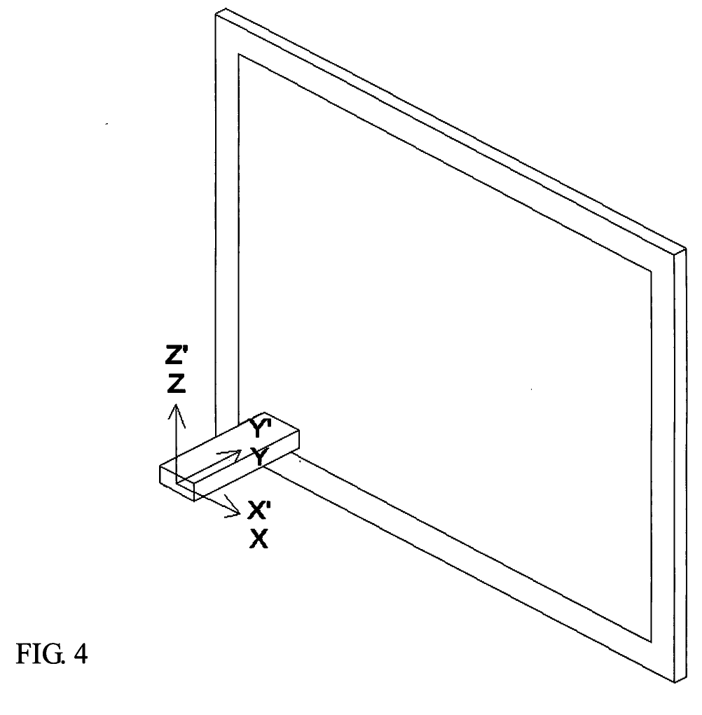

FIG. 3 shows a functional block diagram of a remote controller that is implemented with three gyroscopes along three axes, i.e., X-axis, Y-axis and Z-axis. The orientation of these three axes will be further described below. The output signals from the gyroscopes are inputted to an analog to digital (A/D) converter to convert the gyroscope signals into digital signals. The digital signals are transmitted to a microprocessor. The microprocessor applies the digitized gyroscope signals to determine an angular movement of the remote controller according to an angular rate detected by the gyroscopes. For example, when the gyroscope of the X-axis senses an angular rate ωₓ (see FIG. 4) relative to the X-axis, a function relationship between the X-axis angular rate and the output value Vₓ of the gyroscope can be expressed as:

ωₓ=(Vₓ−V_{offsetx})/V_{sensitivityx}

Wherein the value V_{offsetx} represents a gyroscope output value when a remote controller has no angular movement and the value V_{sensitivityx} represents a conversion coefficient between the value of (Vₓ−V_{offsetx}) in a unit of volt to a value ωₓ defined in a unit of rad/sec. The microprocessor of the remote controller computes an angular rate according to the voltage signals received from the gyroscopes. The angular rate data is transmitted to another processor of the home entertainment center. The processor of the home entertainment center integrated the angular rates over time to obtain an angular movement of the remote controller. The processor of the home entertainment center applies the value of the angular movement of the remote controller to control the movements of the highlighted selections on a display menu shown on the image screen. Therefore, a rotational movement of a remote controller is applied to move the selection of a highlighted item on an operational menu. The requirement of a remote controller user to push a button to shift and change the selection of highlighted items on a selection menu is therefore eliminated.

For the purpose of saving energy, a remote controller may be controlled to operate in a sleep mode if it has been put on a table without any moving for a long time. When the user starts to move the remote controller by lifting it up from a table, holding it in the air and stop the motion for a very short period such as half second, the remote controller is triggered to start an active mode. This process is called a “reset” operation.

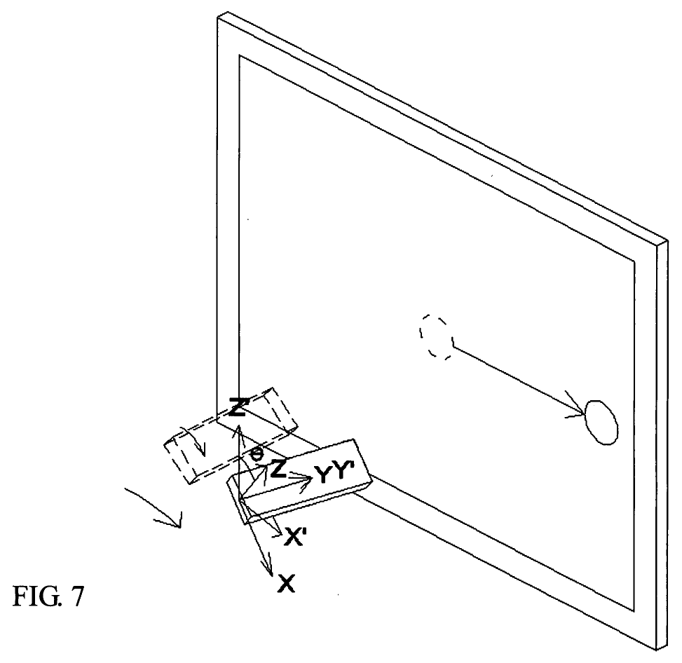

A reset operation achieves an important purpose for setting up a reference coordinate for measuring the angular movements. FIG. 4 shows that the remote controller has three axes along three mutually perpendicular directions. The remote controller is shown as a rectangular box with the elongated direction shown as the Y-axis. The upward direction is represented as the Z-axis and the horizontal direction as the X-axis. When the user starts a reset operation, it is suggested that the X-axis of the remote controller is substantially parallel to the bottom edge of the display screen. At this moment, the reference coordinates of the home entertainment center are set up. The X′-axis, Y′-axis, and Z′-axis of the reference coordinates are parallel to and aligned with the coordinate axes of the remote controller. The processor of the entertainment center set a time to zero to start a time integration of the angular movements of the remote controller. Starting from this time zero, so long as there are no rotational angular movements of the remote controller relative to the Y-axis that is aligned with Y′ axis, then the coordinate-axes of the remote controller is maintained as aligned with the coordinate-axes of the home entertainment center. When the remote controller rotates an angle of θ relative to the Y-axis, the X-axis and the Z-axis also rotate an angle of θ relative to the original orientation. As shown in FIG. 7, under such condition, the X′-axis, the Y′-axis and the Z′-axis are still kept at the same position, and the Y-axis is still aligned with the Y′-axis. After the reset, a user may execute some operation to turn on the center if it is in standby state. One exemplary embodiment is turning the remote controller about the Y′-axis a clockwise direction to an orientation (or pitch) of approximately 90 degrees and then returning to the original position.

The button provided in a regular remote controller of a home entertainment center may be categorized into three different kinds. The first kind of push-buttons includes the frequently used buttons such as power button, volume control, channel control, and the numeral keys for channel selections. The second kind of buttons includes the buttons for selection of menu items and the buttons to shift the selection to a next item on the right-left-up-down of the current selectable item. The third kind of buttons is the buttons that are infrequently used that may include button for tuning the operation of the home entertainment center. The power-on operation discussed above may be applied to replace the conventional power-On/Off button. The functions performed by the volume control button and channel control button can also be replaced by applying rotational movement of the remote controller without pushing buttons again. In an exemplary embodiment, when the remote controller is lifted up from a table to start a reset operation followed by turning the remote controller along a clockwise direction to an orientation of approximately 135 degrees about the Y′-axis that is the pitch is 135 degrees, and remain at that position for about half second, the operation of the home entertainment center enters into a frequently-used button mode. The volume control menu and channel control menu are shown on an image screen. The remote controller may be rotated relative to the X′-axis by making an upward (or downward) movement and returning to a horizontal position to increase (or decrease) a channel number by one. On the other hand, the remote controller may be rotated relative to the Z′-axis by making a rightward (or leftward) rotation and returning to the original position to increase (or decrease) one scale of the volume control. Of course such controlled can be adjusted with greater angular movements of the remote controller to achieve a greater degree of the channel or the volumes adjustments corresponding to the angular movements of the remote controller. Then, by rotating the remote controller relative to the Y′-axis along a counter clockwise direction to an orientation of approximately 135 degrees and remain unmoved for about half a second, the frequently pushed button mode of the remote controller is terminated. In an alternate embodiment, by rotating the remote controller relative to the Y-axis clockwise for 180 degrees after the initial power-on/recess operation described above, the remote controller enters into a numerical operation mode for channel selection. A numerical keyboard is displayed on the image screen of the home entertainment center. Channel selection is controlled by applying the control methods described below to highlight a numerical key on the screen and followed by rotating the remote controller for 180 degrees counterclockwise about the Y′-axis then turning back 180 degrees clockwise as an operation for selecting a the numeral channel number. Different operational methods can be predefined and operated by rotating the remote controller in different way as a user may prefer. It is optional that a user is provided with flexibility to choose different ways of motions of the remote controller to accomplish different control functions to replace the convention methods of pushing down different buttons.

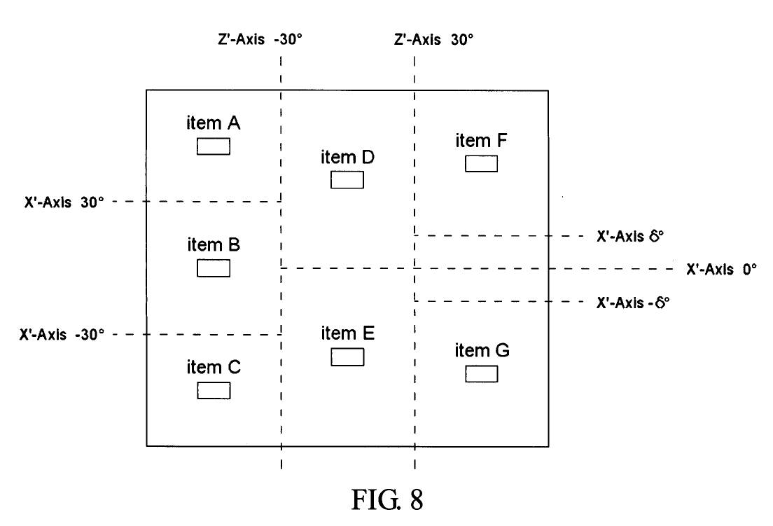

For the purpose of highlighting the selectable items on a selection menu, the image screen is divided into different regions and each selectable item is shown on the image screen in a different region. Each region is further associated and corresponded to a angular range for rotating the remote controller relative to the X′ and Z′ axes. When the remote controller is rotated to a certain angular position a corresponding region is highlighted as a selectable item. Normally, when the remote controller is placed at zero degree of rotation relative to the X′ and Z′ axes, the highlighted selectable item is the central middle item. A user can rotate the remote controller relative to the Z′-axis to select different selectable items along the horizontal level. Different selectable items along the vertical line are selectable by rotating the remote controller about the X′-axis. As shown in FIG. 8, when the remote controller is rotated about the Z′-axis between +−30 degrees and about the X′-axis for greater than 0 degrees, the D region is highlighted and when the Z′ rotation is greater than 30 degrees and X′ rotation is greater than 0 degrees, the region F will be highlighted, when the Z′ rotation is greater than 30 degrees and X′ rotation is less than 0 degrees, the region G will be highlighted. The highlighted region may be displayed with a special highlighted color in the selected region. An operation of rotating the remote controller back to zero degree relative to the reference axes Y′, may be applied as an operation to make a selection.

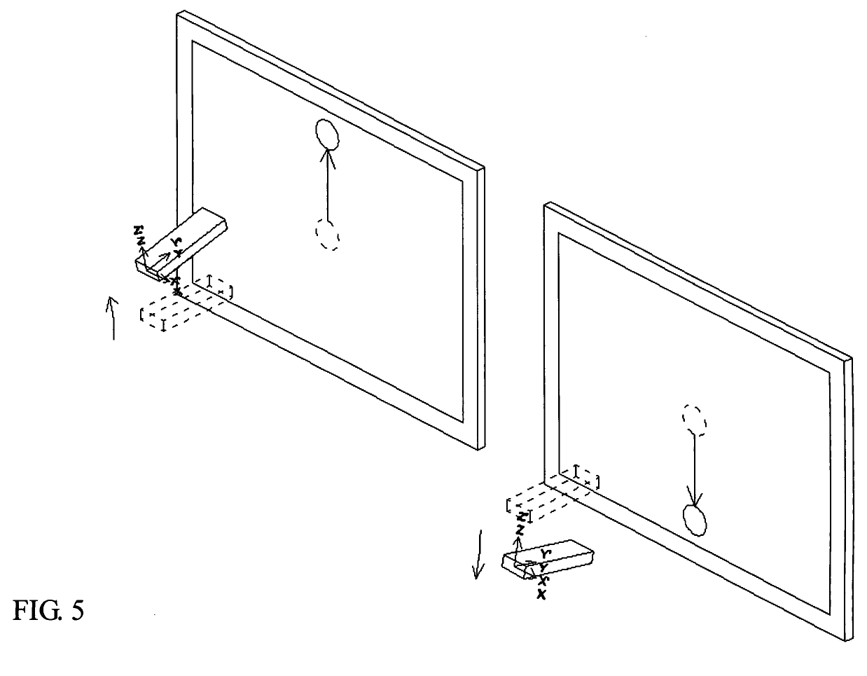

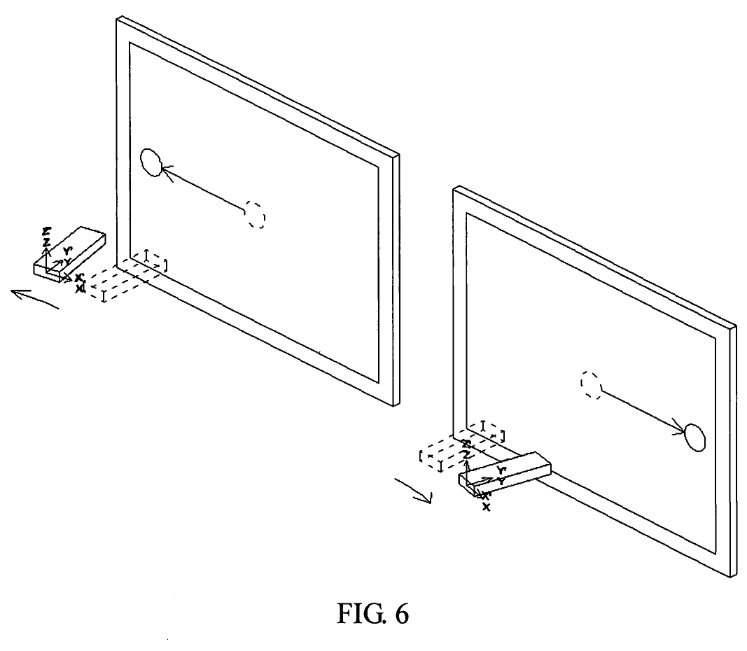

The processor of the home entertainment center carries out a function of receiving the signal from the remote controller representing the angular rates of the remote controller. The processor then carries out a time-integration over a predefined time period to determine the angular position of the remote controller at certain time after a reset operation or a time from last control or selection operation as confirmed by the movement of the remote controller by turning back to a Y′-axis zero-degree position described above. Initially when a user starts to hold and move rotate the remote controller, for example, about the X′-axis as shown in FIG. 5, the gyroscope detects a X′-axis angular rate and generates a corresponding voltage. The voltage is digitized and transmitted to the processor of the home entertainment center. The processor performs an integration process to compute the relative X′ angle. Referring to FIG. 6, the same kinds of operations are also carried out for angular movements relative to the Z′-axis. Based on these angular movement values obtained by the processor corresponding to the movements of the remote controller, the processor of the home entertainment center is able to choose a corresponding region as the highlighted item on an operational menu. Therefore, a user of the remote controller is provided with flexibility to move the remote controller without requiring to push buttons to change the selectable highlighted items and to make selections without using the push buttons just by rotating the remote controller back to the aligned zero-degree position as described in the above exemplary embodiments.

FIG. 7 shows the angular orientation of a remote controller rotated about the Y′-axis/Y-axis with an angle of θ where θ≠0 degree. Under this circumstance, the X-axis and the Z-axis are also rotated relative to the Y′-axis/Y-axis while the X′ and Z′ axes are still kept at the same orientation. The purpose of the arrangement is that the operation of the remote controller is similar to what we mentioned before and not affected even a user may hold the remote controller with a relative rotation angle about the Y′-axis. The processor of the entertainment center is able to detect and determine the user's selections of highlighted regions based on the movement of the remote controller. A horizontal rotation will continuously move the selection along a horizontal level while an up-down rotation of the remote controller will control the selected highlighted region to change along a vertical direction. The rotational angles movements along each of these references axes can be represented as follows for the angular rate ω_{z} and ω_{z′} about the Z-axis and Z′ axis respectively and angular rate ωₓ and ω_{x′} about the X axis and X′ axis respectively:

ωx′=ωx×cos θ+ωz×sin θ

ωz′=−ωx×sin θ+ωz×cos θ

In comparison to the conventional methods, the remote controller of this invention is faster, more comfortable and intuitive without requiring the operation of pushing several buttons to make a selection. Faster and more convenient control of the home entertainment center is therefore accomplished.

The above descriptions are only for one exemplary embodiment. The home entertainment center may include many more different devices and systems. The tilt rotational angle θ about the Y′-axis/Y-axis of the remote controller may be implemented to control different device depending the value of the tilt rotational angle θ relative to a horizontal direction of the remote controller. For example when the remote controller has a rotational angle θ of 135 degrees and 180 degrees may be implemented to carry out such functions. The remote controller may then be rotated along about the X-axis and Z-axis to highlight a selectable item and then rotated about Y-axis angle θ in reverse directions for making a selection.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A method for controlling an electronic device comprising:
moving a wireless remote controller without pressing down a control button on the wireless remote controller.
